(19) United States
(12) Patent Application Publication
(10) Pub. No.: US 2025/0263325 A1
(43) Pub. Date: Aug. 21, 2025

(54) GLASS SUBSTRATE FOR MAGNETIC RECORDING MEDIUM, GLASS DISK FOR MAGNETIC RECORDING MEDIUM, METHOD FOR MANUFACTURING MAGNETIC RECORDING MEDIUM, AND METHOD FOR MANUFACTURING GLASS DISK

(71) Applicant: Nippon Electric Glass Co., Ltd., Shiga (JP)

(72) Inventor: Shinkichi MIWA, Shiga (JP)

(21) Appl. No.: 18/706,446

(22) PCT Filed: Nov. 29, 2022
(86) PCT No.: PCT/JP2022/044030

§ 371 Date: May 1, 2024

(30) Foreign Application Priority Data
Dec. 1, 2021 (JP) 2021-195306

(51) Int. Cl. C03C 3/093; G11B 5/73; G11B 5/84

(52) U.S. Cl. CPC C03C 3/093; G11B 5/73921; G11B 5/8404

(57) ABSTRACT

A glass substrate for a magnetic recording medium of the present invention has an average coefficient of linear thermal expansion within a temperature range of from 30° C. to 380° C. of from 30×10⁻⁷/° C. to 40×10⁻⁷/° C., a Young's modulus of 80 GPa or more, a specific Young's modulus of 30 GPa/g·cm⁻³ or more, and a strain point of 700° C. or more.

### TECHNICAL FIELD

The present invention relates to a glass substrate for a magnetic recording medium, a glass disk for a magnetic recording medium, a magnetic recording medium, and a method of manufacturing a glass disk.

### BACKGROUND ART

A magnetic recording device includes a magnetic recording medium having a magnetic layer formed on a disk for a magnetic recording medium, and can record information through use of the magnetic layer. An aluminum alloy disk has hitherto been used as the disk for a magnetic recording medium used in the magnetic recording device, but nowadays, a glass disk, which is excellent in hardness, flatness, and smoothness as compared to the aluminum alloy disk, is also used in response to a demand for an increase in recording density.

In recent years, in order to meet a need for a further increase in recording density, a magnetic recording medium using an energy-assisted magnetic recording (HAMR) mode, that is, an energy-assisted magnetic recording medium has been investigated. The glass disk is used also in the energy-assisted magnetic recording medium, and the magnetic layer or the like is formed on the surface of the glass disk.

In the energy-assisted magnetic recording medium, an ordered alloy having a high magnetic anisotropy coefficient Ku (hereinafter referred to as “high Ku”) is used as a magnetic material of the magnetic layer. In order to increase the degree of order (order parameter) of the magnetic layer to achieve a high Ku, a base material including the glass disk is subjected to heat treatment at a high temperature of from 600° C. to 800° C. at the time of formation of the magnetic layer, or before and after the formation. In addition, the base material including the glass disk may be subjected to laser irradiation after the formation of the magnetic layer. Such heat treatment and laser irradiation are also intended to increase the annealing temperature and coercive force of a magnetic layer containing an FePt-based alloy or the like.

### SUMMARY OF INVENTION

### Technical Problem

Incidentally, a glass disk for a magnetic recording medium is required to have high rigidity (Young's modulus) in order to prevent large deformation at the time of high-speed rotation.

Specifically, in a magnetic recording medium including the glass disk, information is written and read along a rotation direction while the medium is rotated at high speed about its central axis and a magnetic head is moved in a radial direction. In recent years, a rotation speed for increasing a writing speed and a reading speed has been increasing from 5,400 rpm to 7,200 rpm, further to 10,000 rpm. In the magnetic recording medium having a disk shape, a position for recording information is assigned in advance in accordance with a distance from the central axis, and hence when the glass disk is deformed during rotation, positional displacement of the magnetic head occurs, which makes accurate reading difficult.

In addition, in recent years, by mounting a dynamic flying height (DFH) mechanism on the magnetic head, a gap between a recording and reproducing element portion of the magnetic head and the surface of the magnetic recording medium has been significantly narrowed (a flying height has been reduced), and thus a further increase in recording density has been achieved. The DFH mechanism is a mechanism in which a heating unit such as a microheater is arranged in the vicinity of the recording and reproducing element portion of the magnetic head, and thus only the periphery of the element portion is thermally expanded toward a medium surface direction. Through incorporation of such mechanism, a distance between the magnetic head and a magnetic layer of the medium is reduced, and hence signals of smaller magnetic particles can be picked up, which enables achievement of an increase in recording density. Meanwhile, the gap between the recording and reproducing element portion of the magnetic head and the surface of the magnetic recording medium is extremely reduced to, for example, 2 nm or less, and hence the magnetic head may collide with the surface of the magnetic recording medium even with a slight impact. As the rotation speed becomes higher, this tendency becomes more remarkable. Accordingly, at the time of high-speed rotation, it is important to prevent occurrence of deflection and flapping (fluttering) of the glass disk, which are causes of the collision.

Further, the glass disk for a magnetic recording medium is also required to have an appropriate coefficient of thermal expansion in order to improve reliability of recording and reproduction of the magnetic recording medium. Specifically, a hard disk drive (HDD) incorporating the magnetic recording medium has a structure in which the magnetic recording medium itself is rotated by pressing a central portion by a spindle of a spindle motor. Accordingly, when a difference in coefficient of thermal expansion between the glass disk and a spindle material is too large, thermal expansion and thermal shrinkage of the glass disk and those of the spindle material in response to a change in ambient temperature differ from each other, with the result that a phenomenon in which the magnetic recording medium is deformed occurs. When such phenomenon occurs, information having been written cannot be read by the magnetic head, and the reliability of recording and reproduction may be impaired. Accordingly, it is desired that the glass disk for a magnetic recording medium have a coefficient of thermal expansion that matches the coefficient of thermal expansion of the spindle material (e.g., stainless steel) as much as possible.

In addition, in recent years, it has been required to increase the number of disks mounted in a drive in order to increase the capacity of the magnetic recording medium. In particular, in a high-capacity drive to be used in a data center, which is called nearline, a plurality of drives in a device are each individually replaced with a high-capacity drive to increase the capacity and speed of the device in its entirety. At this time, the drive is replaced in a space having the same volume. Accordingly, the thickness of the glass disk is reduced in order to increase the number of disks. However, when the thickness of the glass disk is reduced, the degree of deformation (deflection) is increased. Particularly when the disk is horizontally arranged, its deformation amount is influenced by the mass of the disk. Accordingly, the glass disk is required to not only have a high Young's modulus, but also have a high specific Young's modulus, which is a value obtained by dividing the Young's modulus by a density.

The present invention has been made in view of the above-mentioned circumstances, and an object of the present invention is to devise a glass disk for a magnetic recording medium, which hardly undergoes deflection and flapping (fluttering) at the time of high-speed rotation, has a small deformation amount at the time of horizontal arrangement, and further has a coefficient of thermal expansion that matches the coefficient of thermal expansion of a spindle material (e.g., stainless steel).

### Solution to Problem

The inventor of the present invention has repeated various experiments, and as a result, has found that the above-mentioned technical object can be achieved by restricting various characteristics of a glass substrate (mother glass sheet) before being processed into a glass disk within predetermined ranges, and the finding is proposed as the present invention. That is, according to one embodiment of the present invention, there is provided a glass substrate for a magnetic recording medium, having an average coefficient of linear thermal expansion within a temperature range of from 30° C. to 380° C. of from 30×10⁻⁷/° C. to 70×10⁻⁷/° C., a Young's modulus of 80 GPa or more, a specific Young's modulus of 30 GPa/g·cm⁻³ or more, and a strain point of 700° C. or more. Herein, the “average coefficient of linear thermal expansion within the temperature range of from 30° C. to 380° C.” may be measured with a dilatometer. The “strain point” refers to a value measured based on a method of ASTM C336. The “Young's modulus” may be measured by a well-known resonance method. The “specific Young's modulus” is a value obtained by dividing the Young's modulus by a density, and the density may be measured, for example, by a well-known Archimedes method.

In the glass substrate for a magnetic recording medium according to the one embodiment of the present invention, the average coefficient of linear thermal expansion within the temperature range of from 30° C. to 380° C. is restricted to 30×10⁻⁷/° C. or more. With this configuration, a difference in coefficient of thermal expansion between a glass disk and a spindle material is reduced, and hence thermal expansion and thermal shrinkage of the glass disk and those of the spindle material in response to a change in ambient temperature easily match each other. As a result, a magnetic recording medium is hardly deformed, and thus reliability of recording and reproduction of the magnetic recording medium can be improved. Further, when a high Ku is to be achieved by performing heat treatment or laser irradiation, differences in thermal expansion and thermal shrinkage between the glass disk and the spindle material can be reduced.

In addition, in the glass substrate for a magnetic recording medium according to the one embodiment of the present invention, the Young's modulus is restricted to 80 GPa or more. With this configuration, deflection and flapping (fluttering) of a glass disk hardly occurs at the time of high-speed rotation, and thus collision between an information recording medium and a magnetic head can be prevented.

In addition, in the glass substrate for a magnetic recording medium according to the one embodiment of the present invention, the specific Young's modulus is restricted to 30 GPa/g·cm⁻³ or more. With this configuration, even when a glass disk is thinned, deflection and flapping of the glass disk hardly occurs, and thus damage caused by collision between an information recording medium and a magnetic head or a peripheral component can be prevented.

In addition, in the glass substrate for a magnetic recording medium according to the one embodiment of the present invention, the strain point is restricted to 700° C. or more. With this configuration, even when heat treatment is performed at high temperature, a glass disk is not deformed, and deformation of the glass disk at the time of manufacture of a magnetic recording medium using an energy-assisted magnetic recording (HAMR) mode can be prevented.

In addition, the glass substrate for a magnetic recording medium according the one embodiment of the present invention preferably comprises as a glass composition, in terms of mass %, 55% to 65% of SiO₂, 15% to 25% of Al₂O₃, 2% to 5.5% of B₂O₃, 0.1% to 10% of MgO, 0.1% to 10% of CaO, 0% to 10% of SrO, 0% to 10% of BaO, and 0% to 1% of ZrO₂.

In addition, the glass substrate for a magnetic recording medium according to the one embodiment of the present invention preferably has a crack generation rate of 50% or less when an indentation is made thereon at a load of 500 g with a Vickers indenter. With this configuration, generation of cracks on an end surface of a glass disk caused, for example, by an impact at the time of manufacture or transportation of a magnetic recording device is prevented, and thus breakage of a magnetic recording medium hardly occurs. Herein, the “crack generation rate” is a value measured as described below. First, in a constant temperature and humidity chamber kept at a humidity of 30% and a temperature of 25° C., a Vickers indenter set to a load of 500 g is pressed into a glass surface for 15 seconds, and 15 seconds later, the number of cracks generated from the four corners of an indentation is counted (the maximum number of cracks is 4 per indentation). The indenter is pressed in this manner 50 times, the total number of generated cracks is determined, and then the crack generation rate is determined by the following expression: (total number of generated cracks/200)×100. The pressing of the Vickers indenter may be performed with a fully automatic Vickers hardness tester (e.g., FLC-50VX manufactured by Future-Tech Corporation). However, a value of the crack generation rate varies depending on a moisture state of a glass surface, and hence it is desired to perform annealing within the temperature range of from (Ps-350° C.) to (Ps-10° C.) for 1 hour or more before the measurement, to thereby cancel a difference in moisture state of the glass surface due to room temperature and a humidity. The “Ps” represents the strain point.

In addition, the glass substrate for a magnetic recording medium according to the one embodiment of the present invention preferably has a Vickers hardness of 640 or more. With this configuration, fine flaws are hardly generated on a main surface. As a result, the surface accuracy of a magnetic recording medium can be maintained. Herein, the “Vickers hardness” refers to a value measured by pressing a Vickers indenter at a load of 100 g with a Vickers hardness tester.

In addition, the glass substrate for a magnetic recording medium according to the one embodiment of the present invention preferably has a content of Na₂O of less than 0.1 mass % in a glass composition. With this configuration, the performance of a magnetic layer to be formed on the surface of a glass disk can be maintained.

In addition, the glass substrate for a magnetic recording medium according to the one embodiment of the present invention preferably has a β-OH value of 0.30/mm or less.

In addition, in the glass substrate for a magnetic recording medium according to the one embodiment of the present invention, an average roughness Ra of a main surface of the glass substrate is preferably 2.0 nm or less. With this configuration, even when a bit size is reduced in order to achieve an increase in recording density, magnetic characteristics can be improved. Herein, the “surface roughness Ra of a main surface” refers to a surface roughness Ra of both surfaces except for an end surface, and may be measured, for example, with an atomic force microscope (AFM). While the glass substrate for a magnetic recording medium according to the one embodiment of the present invention is finally processed into a disk shape through a processing process, such as a cutting step and a polishing step, it is desired that a surface roughness Ra of a glass disk also be similarly 2.0 nm or less. Thus, a high precision glass surface is easily obtained.

In addition, the glass substrate for a magnetic recording medium according to the one embodiment of the present invention preferably has an average linear transmittance at an optical path length of 0.7 mm within a wavelength range of from 350 nm to 1,500 nm of 70% or more. With this configuration, when a high Ku is to be achieved by performing laser irradiation, a magnetic layer is sufficiently irradiated with laser light, and thus the recording density of a magnetic recording medium can be efficiently increased. Herein, the “average linear transmittance at an optical path length of 0.7 mm within the wavelength range of from 350 nm to 1, 500 nm” may be measured with a commercially available spectrophotometer, and for example, Spectrophotometer UV-3100 manufactured by Shimadzu Corporation or U-4000 manufactured by Hitachi, Ltd. may be used.

In addition, the glass substrate for a magnetic recording medium according to the one embodiment of the present invention preferably has a substantially rectangular shape having dimensions larger than or equal to a 500 mm square, and has a sheet thickness of 0.7 mm or less. With this configuration, a plurality of glass disks can be acquired from one glass substrate, and thus the productivity of a glass disk is improved.

In addition, in the glass substrate for a magnetic recording medium according to the one embodiment of the present invention, a main surface of the glass substrate is preferably essentially a fire-polished surface.

A glass disk for a magnetic recording medium according to one embodiment of the present invention is preferably manufactured from the above-mentioned glass substrate for a magnetic recording medium.

In addition, the glass disk for a magnetic recording medium according to the one embodiment of the present invention has an average coefficient of linear thermal expansion within a temperature range of from 30° C. to 380° C. of from 30×10⁻⁷/° C. to 70×10⁻⁷/° C., a Young's modulus of 80 GPa or more, a specific Young's modulus of 30 GPa/g·cm⁻³ or more, and a strain point of 700° C. or more.

In addition, the glass disk for a magnetic recording medium according the one embodiment of the present invention preferably comprises as a glass composition, in terms of mass %, 55% to 65% of SiO₂, 15% to 25% of Al₂O₃, 2% to 5.5% of B₂O₃, 0.1% to 10% of MgO, 0.1% to 10% of Cao, 0% to 10% of SrO, 0% to 10% of BaO, and 0% to 1% of Zro₂.

In addition, a magnetic recording medium according to one embodiment of the present invention preferably comprises the above-mentioned glass disk for a magnetic recording medium.

A method of manufacturing a glass disk according to one embodiment of the present invention is preferably a method of manufacturing a glass disk, comprising processing a glass substrate for a magnetic recording medium to provide a glass disk, wherein the glass substrate for a magnetic recording medium is the above-mentioned glass substrate for a magnetic recording medium.

### BRIEF DESCRIPTION OF DRAWINGS

FIG. 1 is a top perspective view for illustrating the shape of a glass disk.

### DESCRIPTION OF EMBODIMENTS

A glass substrate for a magnetic recording medium of the present invention has an average coefficient of linear thermal expansion within the temperature range of from 30° C. to 380° C. of from 30×10⁻⁷/° C. to 70×10⁻⁷/° C. or more, preferably from 31×10⁻⁷/° C. to 70×10⁻⁷/° C., from 32×10⁻⁷/° C. to 65×10⁻⁷/° C., from 33×10⁻⁷/° C. to 60×10⁻⁷/° C., from 34×10⁻⁷/° C. to 55×10⁻⁷/° C., or from 35×10⁻⁷/° C. to 45×10⁻⁷/° C., particularly preferably from 35×10⁻⁷/° C. to 40×10⁻⁷/° C. When the average coefficient of linear thermal expansion within the temperature range of from 30° C. to 380° C. is outside the above-mentioned ranges, a difference in coefficient of thermal expansion between a glass disk and a spindle material is increased, and hence thermal expansion and thermal shrinkage of the glass disk and those of the spindle material in response to a change in ambient temperature hardly match each other. As a result, a magnetic recording medium is liable to be deformed, and reliability of recording and reproduction of the magnetic recording medium is liable to be reduced.

The glass substrate for a magnetic recording medium of the present invention has a Young's modulus of 80 GPa or more, preferably 81 GPa or more, more preferably 82 GPa or more, particularly preferably from 83 GPa to 120 GPa. When the Young's modulus is too low, deflection or flapping of a glass disk is liable to occur at the time of high-speed rotation, and hence an information recording medium and a magnetic head are liable to collide with each other.

The glass substrate for a magnetic recording medium of the present invention has a specific Young's modulus of 30 GPa/g·cm⁻³ or more, preferably 31 GPa/g·cm⁻³ or more or 32 GPa/g·cm⁻³ or more, particularly preferably 33 GPa/g·cm⁻³ or more. When the specific Young's modulus is too low, in the case where a glass disk is thinned, deflection or flapping of the glass disk is liable to occur, and hence an information recording medium and a magnetic head are liable to collide with each other.

The glass substrate for a magnetic recording medium of the present invention has a strain point of 700° C. or more, preferably 710° C. or more, particularly preferably 720° C. or more. When the strain point is too low, a glass disk is liable to be deformed through heat treatment at high temperature.

The glass substrate for a magnetic recording medium (and glass disk for a magnetic recording medium) of the present invention preferably comprises as a glass composition, in terms of mass %, 55% to 65% of SiO₂, 15% to 25% of Al₂O₃, 2% to 5.5% of B₂O₃, 0.1% to 10% of MgO, 0.1% to 10% of CaO, 0% to 10% of SrO, 0% to 10% of BaO, and 0% to 1% of Zro₂. The reasons why the contents of the components are limited as described above are described below. In the description of the contents of the components, the expression “%” represents “mass %” unless otherwise stated.

SiO₂ is a component that forms a glass network. The content of SiO₂ is preferably from 55% to 65%, from 56% to 64%, from 57% to 63%, from 58% to 63%, or from 59% to 62.5%. When the content of SiO₂ is too small, vitrification becomes difficult, and heat resistance is liable to be reduced. In addition, a liquidus viscosity is increased, with the result that down-draw forming becomes difficult. In addition, a density is increased, with the result that the specific Young's modulus is liable to be reduced. Meanwhile, when the content of SiO₂ is too large, the viscosity of a glass melt is increased, with the result that meltability and formability are liable to be reduced. In addition, a liquidus temperature is increased, with the result that forming becomes difficult. In addition, the coefficient of thermal expansion is excessively reduced.

Al₂O₃ is a component that increases the Young's modulus, and also increases the strain point and an annealing point to improve the heat resistance. The content of Al₂O₃ is preferably from 15% to 25%, from 16% to 24%, from 17% to 23%, or from 18% to 22%, particularly preferably from 18% to 21%. When the content of Al₂O₃ is too small, the Young's modulus is reduced. In addition, the heat resistance and the annealing point are liable to be reduced. Meanwhile, when the content of Al₂O₃ is too large, the liquidus temperature is reduced, with the result that forming by an overflow down-draw method becomes difficult.

B₂O₃ is a component that forms the glass network to improve solubility, and also reduces the liquidus temperature to improve devitrification resistance. In addition, B₂O₃ is also a component that improves scratch resistance. The content of B₂O₃ is preferably from 2% to 5.5% or from 2.2% to 5%, particularly preferably from 2.5% to 5%. When the content of B₂O₃ is too small, the scratch resistance is reduced, and also the liquidus temperature is reduced, with the result that forming by an overflow down-draw method becomes difficult. In addition, glass becomes fragile, with the result that a defect such as chipping is liable to occur at the time of processing, such as cutting and polishing. Meanwhile, when the content of B₂O₃ is too large, the Young's modulus is reduced, with the result that rigidity is reduced. In addition, the strain point and the annealing point are reduced, with the result that heat resistance is liable to be reduced.

MgO is a component that significantly increases the Young's modulus. In addition, MgO is also a component that reduces a viscosity at high temperature to improve the meltability and the formability. The content of MgO is preferably from 0.1% to 10%, from 0.5% to 9%, from 0.5% to 8%, from 0.5% to 78, or from 1% to 6.58, particularly preferably from 1.5% to 6%. When the content of MgO is too small, the Young's modulus and the solubility are reduced, and also the scratch resistance is liable to be reduced. Meanwhile, when the content of MgO is too large, the liquidus temperature is increased and the liquidus viscosity is reduced, with the result that the devitrification resistance is liable to be reduced.

B₂O₃+MgO (the total content of B₂O₃ and MgO) is preferably from 5% to 10%, from 5% to 9%, or from 5% to 8.5%, particularly preferably from 5% to 8%. With this configuration, both a high strain point and high scratch resistance are easily achieved.

CaO is a component that increases the Young's modulus, and also reduces the viscosity at high temperature to improve the meltability and the formability. The content of Cao is preferably from 0.1% to 10%, from 1% to 128, or from 2% to 10%, particularly preferably from 3% to 78. When the content of CaO is too small, it becomes difficult to exhibit the above-mentioned effects. Meanwhile, when the content of Cao is too large, the devitrification resistance is liable to be reduced.

A mass percent ratio (B₂O₃+MgO)/CaO (a value obtained by dividing the total content of B₂O₃ and MgO by the content of Cao) is preferably from 1.0 to 2.0, particularly preferably from 1.0 to 1.8. With this configuration, both a high strain point and high devitrification resistance are easily achieved.

SrO is a component that reduces the viscosity at high temperature to improve the meltability and the formability. In addition, the content of SrO is preferably from 0% to 10%, from 0.1% to 8%, or from 0.5% to 6%, particularly preferably from 1.5% to 6%. When the content of SrO is too large, the devitrification resistance is liable to be reduced. In addition, the density is increased, with the result that the specific Young's modulus is liable to be reduced.

BaO is a component that slightly reduces the viscosity at high temperature to improve the meltability. In addition, BaO stabilizes the glass, and hence has a reducing effect on the liquidus temperature and an increasing effect on the liquidus viscosity. The content of BaO is preferably from 0% to 10%, from 0.1% to 10%, or from 0.5% to 8%, particularly preferably from 0.5% to 7%. When the content of BaO is too large, the density is increased, with the result that the specific Young's modulus is liable to be reduced.

Zro₂ is a component that increases the Young's modulus, but when the content thereof is too large, the devitrification resistance is liable to be reduced. In addition, a raw material thereof is expensive, which may result in a rise in manufacturing cost. The content of Zro₂ is preferably from 0% to 1%, particularly preferably from 0.01% to 1%.

In addition to the above-mentioned components, the following components, for example, may be added.

ZnO is a component that reduces the viscosity at high temperature to remarkably improve the meltability. The content of ZnO is preferably from 0% to 7% or from 0.1% to 5%, particularly preferably from 0.5% to 3%. When the content of ZnO is too small, it becomes difficult to exhibit the above-mentioned effect. When the content of ZnO is too large, the glass is liable to devitrify. Besides, the strain point is reduced, with the result that the heat resistance is liable to be reduced.

TiO₂ is a component that improves water resistance and weather resistance, but is a component that colors the glass. Accordingly, the content of TiO₂ is preferably from 0% to 0.5%, particularly preferably from 0.005% to less than 0.1%.

Y₂O₃ and La₂O₃ are each a component that increases the Young's modulus, but when the total content of those components is too large, the devitrification resistance is liable to be reduced. In addition, raw materials thereof are expensive, which may result in a rise in manufacturing cost. Further, the density is increased, with the result that the specific Young's modulus may be reduced. The total content of those components and the content of each of those components are preferably 5% or less, 3% or less, or 1% or less, particularly preferably less than 0.1%.

Li₂O, Na₂O, and K₂O are each a component that reduces the viscosity at high temperature to improve the meltability and the formability, but are each a component that reduces the water resistance and the weather resistance. The total content of Li₂O, Na₂O, and K₂O and the content of each of Li₂O, Na₂O, and K₂O are preferably from 0.005% to 0.2% or from 0.01% to 0.1%, particularly preferably from 0.01% to less than 0.1%. When the contents of Li₂O, Na₂O, and K₂O are too large, the performance of a magnetic layer to be formed on the surface of a glass disk is liable to be reduced.

As a fining agent, one kind or two or more kinds selected from the group consisting of: SnO₂; Cl; SO₃; and CeO₂ (preferably the group consisting of: SnO₂; and SO₃) may be added at a content of from 0.05% to 0.5%.

Fe₂O₃ is a component that is inevitably mixed in glass raw materials as an impurity, and is also a coloring component. Accordingly, the content of Fe₂O₃ is preferably 0.5% or less, from 0.001% to 0.1%, from 0.005% to 0.07%, or from 0.008% to 0.03%, particularly preferably from 0.008% to 0.025%. When the content of Fe₂O₃ is too large, an average linear transmittance within the wavelength range of from 350 nm to 1, 500 nm is liable to be reduced.

It is preferred that the glass substrate be substantially free of As₂O₃, Sb₂O₃, PbO, Bi₂O₃, and F as a glass composition from the standpoint of environmental considerations. Herein, the phrase “substantially free of” refers to the case in which the explicit component is not positively added as a glass component but mixing thereof as an impurity is permitted, and specifically refers to the case in which the content of the explicit component is less than 0.05%.

The glass substrate for a magnetic recording medium (and glass disk for a magnetic recording medium) of the present invention preferably has the following characteristics.

A crack generation rate when an indentation is made at a load of 500 g with a Vickers indenter is preferably 50% or less, 40% or less, or 30% or less, particularly preferably 20% or less. When the crack generation rate is too high, cracks are liable to be generated on an end surface of a magnetic recording medium (glass disk), and breakage of the magnetic recording medium (glass disk) is liable to occur.

A Vickers hardness is preferably 640 or more, more preferably 650 or more, particularly preferably 660 or more. When the Vickers hardness is too low, fine flaws are liable to be generated on a main surface, and the average surface roughness Ra may be increased.

The liquidus temperature is preferably 1, 300° C. or less, 1,280° C. or less, 1,260° C. or less, 1,250° C. or less, or 1, 240° C. or less, particularly preferably 1, 230° C. or less. The liquidus viscosity is preferably 10^{3.8} dPa·s or more, 10^{4.4} dPa·s or more, 10^{4.6} dPa·s or more, or 10^{4.8} dPa·s or more, particularly preferably 10^{5.0} dPa·s or more. With this configuration, a devitrified crystal is less liable to precipitate at the time of forming, and the glass is easily formed into a sheet shape by an overflow down-draw method or the like. Accordingly, the average surface roughness Ra of a surface is easily controlled to 2.0 nm or less, 1.0 nm or less, or 0.5 nm or less, particularly 0.2 nm or less without surface polishing or with slight polishing. As a result, magnetic characteristics can be improved through a reduction in bit size. In addition, a reduction in cost of a glass disk can be achieved through reductions in devitrified crystal amount and polishing amount. Herein, the “liquidus temperature” may be calculated by placing glass powder having passed through a standard 30-mesh sieve (500 μm) and remained on a 50-mesh sieve (300 μm) in a platinum boat, keeping the platinum boat for 24 hours in a gradient heating furnace, and measuring a temperature at which a crystal precipitates. The “liquidus viscosity” refers to a glass viscosity at the liquidus temperature, and may be measured by a platinum sphere pull up method.

An average linear transmittance at an optical path length of 0.7 mm within the wavelength range of from 350 nm to 1, 500 nm is preferably 70% or more or 80% or more, particularly preferably 90% or more. When the average linear transmittance at an optical path length of 0.7 mm within the wavelength range of from 350 nm to 1, 500 nm is too low, a magnetic layer is not sufficiently irradiated with laser light at the time of laser irradiation, and it becomes difficult to achieve a high Ku of the magnetic layer.

A β-OH value is preferably 0.30/mm or less, 0.25/mm or less, or 0.20/mm or less, particularly preferably 0.15/mm or less. When the β-OH value is too high, the strain point and the annealing point are reduced, with the result that the heat resistance may be reduced. When the β-OH value is to be extremely reduced, for example, introduction of nitrogen into a melting atmosphere, or introduction of a dry component such as chlorine thereinto is required, which results in increases in melting facility cost and operation cost. Accordingly, the β-OH value is preferably 0.05/mm or more.

As a method of reducing the β-OH value, the following methods are given: (1) a method involving selecting raw materials having low water contents; (2) a method involving adding a component (such as Cl or SO₃) that reduces the β-OH value to the glass; (3) a method involving reducing the amount of water in a furnace atmosphere such as introducing nitrogen into a melting atmosphere; (4) a method involving performing N₂ bubbling in molten glass; (5) a method involving adopting a small melting furnace; (6) a method involving increasing the flow rate of molten glass; and (7) a method involving adopting an electric melting method.

Herein, the “β-OH value” refers to a value determined from the following formula by measuring transmittances with an FT-IR.

$$β - OH value = ( 1 / X ) log ( {T}_{1} / {T}_{2} )$$

X: Sheet thickness (mm)
T₁: Transmittance (%) at a reference wavelength of 3,846 cm⁻¹
T₂: Minimum transmittance (%) at a wavelength around a hydroxyl group absorption wavelength of 3,600 cm⁻¹

The average roughness Ra of the main surface is preferably 2.0 nm or less, 1.0 nm or less, 0.7 nm or less, or 0.5 nm or less, particularly preferably 0.2 nm or less. When the average roughness Ra of the main surface is too large, improvement in magnetic characteristics cannot be expected even when a bit size is reduced in order to achieve an increase in recording density.

A sheet thickness is preferably 1.5 mm or less, 1.0 mm or less, or from 0.2 mm to 0.7 mm, particularly preferably from 0.3 mm to 0.6 mm. When the sheet thickness is too large, it is required to perform mechanical polishing or chemical polishing up to a desired sheet thickness, and it is required to perform polishing up to a desired sheet thickness, which may result in a rise in processing cost.

It is desired that the glass substrate for a magnetic recording medium of the present invention be formed by an overflow down-draw method or a slit down-draw method. In addition, it is preferred that a main surface thereof be substantially a fire-polished surface (an effective surface on which a magnetic layer is to be formed be a fire-polished surface). With this configuration, the main surface of the glass substrate becomes smooth, and fine cracks on the main surface are reduced, with the result that the mechanical characteristics and strength of the glass substrate are improved. Further, chipping or the like is less liable to occur when the glass substrate is processed into a glass disk in a processing process.

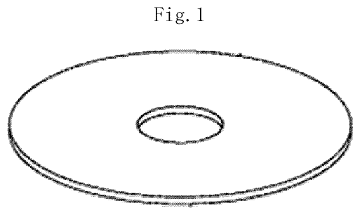

The glass substrate for a magnetic recording medium of the present invention is finally formed from a rectangular shape into a disk shape, that is, a shape which is a circular disk shape and in which a circular opening is formed in a central portion (see FIG. 1) by being subjected to a processing process, such as a polishing step and a cutting step, to thereby provide a glass disk. Moreover, the glass disk is mounted to a magnetic recording device. The shape of the glass disk is illustrated in FIG. 1.

The dimensions of the glass substrate are desirably equal to or larger than a 500 mm square, particularly equal to or larger than a 1,000 mm square. When the dimensions are large, a large number of glass disks can be acquired from one glass substrate, and thus the productivity of the glass disk is improved.

### Example 1

The present invention is described below by way of Examples. Examples below are merely examples. The present invention is by no means limited to Examples below.

Examples of the present invention are shown in Table 1.

TABLE 1

| | Unit | No. 1 | No. 2 | No. 3 | No. 4 | No. 5 |
|---|---|---|---|---|---|---|
| SiO₂ | Mass % | 60.0 | 62.0 | 60.0 | 62.0 | 61.0 |
| Al₂O₃ | Mass % | 20.0 | 20.0 | 19.0 | 19.0 | 19.0 |
| B₂O₃ | Mass % | 4.0 | 3.0 | 3.0 | 4.0 | 2.5 |
| MgO | Mass % | 3.5 | 2.0 | 3.0 | 3.0 | 6.0 |
| CaO | Mass % | 5.5 | 4.5 | 5.0 | 5.0 | 6.0 |
| SrO | Mass % | 2.5 | 1.5 | 1.0 | 5.0 | 3.0 |
| BaO | Mass % | 4.0 | 6.9 | 8.8 | 2.0 | 2.5 |
| ZnO | Mass % | 0.0 | 0.0 | 0.0 | 0.5 | 0.0 |
| ZrO₂ | Mass % | 0.02 | 0.01 | 0.03 | 0.03 | 0.01 |
| SnO₂ | Mass % | 0.2 | 0.15 | 0.25 | 0.3 | 0.2 |
| TiO₂ | Mass % | 0.01 | 0.01 | 0.02 | 0.02 | 0.005 |
| B₂O₃ + MgO | Mass % | 7.5 | 5.0 | 6.0 | 7.0 | 8.5 |
| (MgO + B₂O₃)/CaO | | 1.36 | 1.10 | 1.20 | 1.40 | 1.42 |
| β-OH value | /mm | 0.16 | 0.1 | 0.25 | 0.15 | 0.15 |
| Coefficient of | 10⁻⁷/° C. | 37 | 37 | 37 | 35 | 38 |
| thermal | | | | | | |
| expansion_{30° C.-380° C.} | | | | | | |
| Density | g/cm³ | 2.546 | 2.551 | 2.57 | 2.52 | 2.54 |
| Strain point | ° C. | 720 | 730 | 710 | 720 | 710 |
| (10^{14.5} dPa · s) | | | | | | |
| Annealing point | ° C. | 780 | 795 | 770 | 780 | 760 |
| (10¹³ dPa · s) | | | | | | |
| Softening point | ° C. | 1,005 | 1,035 | 995 | 1,010 | 980 |
| (10^{7.6} dPa · s) | | | | | | |
| 10^{4.0} dPa · s | ° C. | 1,310 | 1,370 | 1,315 | 1,320 | 1,300 |
| 10^{3.0} dPa · s | ° C. | 1,465 | 1,540 | 1,471 | 1,500 | 1,450 |
| 10^{2.5} dPa · s | ° C. | 1,565 | 1,640 | 1,570 | 1,600 | 1,530 |
| Liquidus | ° C. | 1,180 | 1,200 | 1,180 | 1,200 | 1,220 |
| temperature | | | | | | |
| Liquidus | dPa · s | 5.3 | 5.4 | 5.2 | 5.1 | 4.8 |
| viscosity Logη | | | | | | |
| Young's modulus | GPa | 82 | 80 | 83 | 81 | 81 |
| Specific Young's | GPa/(g/cm³) | 32.2 | 31.4 | 32.3 | 32.1 | 32.1 |
| modulus | | | | | | |
| Crack generation | % | 20 | 30 | 30 | 25 | 45 |
| rate (at a load | | | | | | |
| of 500 g) | | | | | | |
| Thermal | ppm | 14 | 13 | 15 | 13 | 16 |
| shrinkage rate | | | | | | |
| (500° C., 60 min) | | | | | | |

First, a glass batch prepared by blending glass raw materials so as to achieve the glass composition shown in the table was loaded in a platinum crucible, and then melted at from 1, 500° C. to 1, 700° C. for 24 hours, fined, and homogenized. In the melting of the glass batch, molten glass was stirred to be homogenized by using a platinum stirrer. Next, the molten glass was poured on a carbon sheet and formed into a sheet shape, followed by being annealed at a temperature around an annealing point for 30 minutes. Each of the resultant glass substrates was evaluated for its β-OH value, average coefficient of linear thermal expansion within the temperature range of from 30° C. to 380° C. CTE_{30° C.-380° C.}, density ρ, strain point Ps, annealing point Ta, softening point Ts, temperature at a viscosity at high temperature of 10^{4.0} dPa·s, temperature at a viscosity at high temperature of 10^{3.0} dPa·s, temperature at a viscosity at high temperature of 10^{2.5} dPa·s, liquidus temperature TL, liquidus viscosity log η, Young's modulus E, specific Young's modulus E/ρ, crack generation rate, and Vickers hardness.

The β-OH value is a value measured by the above-mentioned method.

The average coefficient of linear thermal expansion within the temperature range of from 30° C. to 380° C. CTE_{30° C.-380° C.} is a value measured with a dilatometer.

The density ρ is a value measured by an Archimedes method.

The strain point Ps, the annealing point Ta, and the softening point Ts are values measured in accordance with methods of ASTM C336 and ASTM C338.

The temperatures at viscosities at high temperature of 10^{4.0} dPa·s, 10^{3.0} dPa·s, and 10^{2.5} dPa·s are each a value measured by a platinum sphere pull up method.

The Young's modulus and the specific Young's modulus each refer to a value measured by a resonance method.

The liquidus temperature TL is a temperature obtained by pulverizing each sample, placing the resultant glass powder having passed through a standard 30-mesh sieve (500 μm) and remained on a 50-mesh sieve (300 μm) in a platinum boat, keeping the platinum boat for 24 hours in a gradient heating furnace set to from 1, 100° C. to 1, 350° C., followed by taking out the platinum boat, and measuring a temperature at which a devitrified crystal (crystal foreign matter) is observed in the glass. The liquidus viscosity log η is a value obtained by measuring a glass viscosity at the liquidus temperature TL by a platinum sphere pull up method.

The crack generation rate and the Vickers hardness are each a value measured by the above-mentioned method.

As apparent from the table, Sample Nos. 1 to 5 each have an average coefficient of linear thermal expansion within the temperature range of from 30° C. to 380° C. CTE_{30° C.-380° C.} of from 35×10⁻⁷/° C. to 38×10⁻⁷/° C., a Young's modulus of 80 GPa or more, a specific Young's modulus of 31.4 GPa/g·cm⁻³ or more, and a strain point of 710° C. or more, and hence are each suitable as a glass substrate for a magnetic recording medium.

### Example 2

A glass batch obtained by blending glass raw materials so as to give the glass composition of each of Sample Nos. 1 to 5 shown in the table was loaded into a melting kiln, followed by being melted at from 1, 500° C. to 1, 700° C. for 24 hours, fined, and homogenized, and was formed into a sheet shape by an overflow down-draw method so as to give a sheet thickness of 0.7 mm. The surface roughness Ra of the main surface of each of the resultant glass substrates was measured with an atomic force microscope (AFM), and as a result, was found to be from 0.10 nm to 0.20 nm. Further, the average linear transmittance at an optical path length of 0.7 mm within the wavelength range of from 350 nm to 1, 500 nm of each of the resultant glass substrates was measured with Spectrophotometer UV-3100 manufactured by Shimadzu Corporation, and as a result, was found to be 90% or more. After that, each of those glass substrates was processed into a glass disk by being subjected to a processing process, such as a polishing step and a cutting step.

1. A glass substrate for a magnetic recording medium, having an average coefficient of linear thermal expansion within a temperature range of from 30° C. to 380° C. of from 30×10⁻⁷/° C. to 70×10⁻⁷/° C., a Young's modulus of 80 GPa or more, a specific Young's modulus of 30 GPa/g cm⁻³ or more, and a strain point of 700° C. or more.

2. The glass substrate for a magnetic recording medium according to claim 1, wherein the glass substrate comprises as a glass composition, in terms of mass %, 55% to 65% of SiO₂, 15% to 25% of Al₂O₃, 2% to 5.5% of B₂O₃, 0.1% to 10% of MgO, 0.1% to 10% of CaO, 0% to 10% of SrO, 0% to 10% of BaO, and 0% to 1% of ZrO₂.

3. The glass substrate for a magnetic recording medium according to claim 1, wherein the glass substrate has a crack generation rate of 50% or less when an indentation is made thereon at a load of 500 g with a Vickers indenter.

4. The glass substrate for a magnetic recording medium according to claim 1, wherein the glass substrate has a Vickers hardness of 640 or more.

5. The glass substrate for a magnetic recording medium according to claim 1, wherein the glass substrate has a content of Na₂O of less than 0.1 mass % in a glass composition.

6. The glass substrate for a magnetic recording medium according to claim 1, wherein the glass substrate has a β-OH value of 0.30/mm or less.

7. The glass substrate for a magnetic recording medium according to claim 1, wherein an average roughness Ra of a main surface of the glass substrate is 2.0 nm or less.

8. The glass substrate for a magnetic recording medium according to claim 1, wherein the glass substrate has an average linear transmittance at an optical path length of 0.7 mm within a wavelength range of from 350 nm to 1,500 nm of 70% or more.

9. The glass substrate for a magnetic recording medium according to claim 1, wherein the glass substrate has a substantially rectangular shape having dimensions larger than or equal to a 500 mm square, and has a sheet thickness of 0.7 mm or less.

10. The glass substrate for a magnetic recording medium according to claim 1, wherein a main surface of the glass substrate is essentially a fire-polished surface.

11. A glass disk for a magnetic recording medium, having an average coefficient of linear thermal expansion within a temperature range of from 30° C. to 380° C. of from 30×10⁻⁷/° C. to 70×10⁻⁷/° C., a Young's modulus of 80 GPa or more, a specific Young's modulus of 30 GPa/g cm⁻³ or more, and a strain point of 700° C. or more.

12. The glass disk for a magnetic recording medium according to claim 11, wherein the glass substrate comprises as a glass composition, in terms of mass %, 55% to 65% of SiO₂, 15% to 25% of Al₂O₃, 2% to 5.5% of B₂O₃, 0.1% to 10% of MgO, 0.1% to 10% of CaO, 0% to 10% of SrO, 0% to 10% of BaO, and 0% to 1% of ZrO₂.

13. A magnetic recording medium, comprising the glass disk for a magnetic recording medium of claim 11.

14. A method of manufacturing a glass disk, comprising processing a glass substrate for a magnetic recording medium to provide a glass disk, wherein the glass substrate for a magnetic recording medium is the glass substrate for a magnetic recording medium of claim 1.
